(19) United States
(12) Patent Application Publication
(10) Pub. No.: US 2002/0040355 A1
(43) Pub. Date: Apr. 4, 2002

(54) System and method for utility meter swipecard

(76) Inventor: Steven D. Weiner, Merrick, NY (US)

Correspondence Address: William F. Mulholland, II, Snell & Wilmer L.L.P., One Arizona Center, 400 East Van Buren, Phoenix, AZ, 85004-2202, US

(21) Appl. No.: 09/915,737

(22) Filed: Jul. 26, 2001

Related U.S. Application Data
(60) Provisional application No. 60/237,265, filed on Oct. 2, 2000.

(51) Int. Cl. G06F 17/00

(52) U.S. Cl. 705/412

(57) ABSTRACT

A system for remote payment of utility usage including a customer terminal and a utility provider server wherein the customer terminal includes a utility meter for collecting utility usage data and an input device configured to receive customer account information. At any time during a billing cycle, a customer may prompt the customer terminal to make payment by inserting account information into the customer terminal. The utility provider server may communicate with the customer terminal to transmit and receive customer account information, payment information, usage data, rate data, and other information.

### RELATED APPLICATIONS

This patent application claims priority to, and the benefit of, U.S. provisional patent application entitled “SYSTEM AND METHOD FOR UTILITY METER SWIPECARD” filed on Oct. 2, 2000, as U.S. Ser. No. 60/237,265, the entire contents of which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

The present invention generally relates to a system for allowing utility customers to pay for utility usage remotely, and more particularly, for allowing utility customers to pay for utility usage by inserting a payment card into a card reader associated with a customer utility terminal.

2. Discussion of Related Art

In recent years, consumers have enjoyed the ability to pay for products at the time of purchase using self-service debit and credit card terminals. For example, many gas stations allow customers to “pay at the pump” by inserting their debit or credit card into a card reader integrated into the gas pump. This typically allows customers to pay with minimal or no need for attendant assistance and generally improves the efficiency of the overall transaction process. Indeed, even supermarkets have been experimenting with self-service checkouts whereby the customer scans each grocery item and then inserts a debit or credit card into a POS terminal to provide payment.

However, when paying bills at home, such as utility bills, customers typically manually write a check at the end of each month for the payment due, or authorize the use of an entered credit card number on the statement that is remitted as payment via regular mail. This payment process is highly inefficient as customers waste time and labor completing payment information, and thereafter, preparing the payment information for mailing, such as, placing the payment information in an envelope with postage fees, and then placing the envelope in a mailbox for postal pickup and delivery to the utility company. Utility companies are also subject to payment inefficiencies as delays in postal delivery, and even loss or theft of the payment correspondence often results in delayed or missed payments which leads to higher collection and transaction costs. Moreover, the customer's checking account may not include sufficient funds, thereby typically resulting in a “bounced” check.

To minimize these concerns, many utility companies offer automatic billing to a customer's debit or credit card of choice, or an automatic draft on their checking account. However, many customers feel uncomfortable giving out this information, as they feel it may be a violation of their privacy. Moreover, under this payment arrangement, the customer often has little control over the exact date that payment will be posted, in that the utility company, not the customer, typically accesses the account. Thus, a need exists for a system and method that allows customers to exercise greater control and flexibility over their payment options and provides payment to utility companies in an expedited and more efficient manner.

Additionally, today's utility market has demonstrated wild fluctuations in the pricing of various utilities. For example, some states have experienced increases in gas and electric utility charges several times greater than in previous years. Thus, a need also exists for a system and method that allows customers to pre-purchase a given amount of a utility at a fixed price in order to minimize uncertain pricing fluctuations in the future.

### SUMMARY OF THE INVENTION

The present invention allows customers to pay for utility usage, such as gas, electricity or water, from their own homes by using a payment card in a POS terminal positioned in association with a utility meter(s). Each utility meter in a customer's home is interfaced with a customer terminal that is configured to acquire utility usage data from the meter. At any time during the billing cycle, the customer may instruct the customer terminal to calculate the payment due, and thereafter, insert a payment card into a reader associated with the terminal to make payment. The terminal reads the account data off the card and packages this data, along with other payment and identification data, using software that acquires meter information. Additionally, customers may also pay their utility bills in a secure manner in accordance with the present invention. The customer terminal software may encrypt the payment data and transmit it to the appropriate utility provider's server, either wirelessly or over a wired computer network. The payment data is decrypted upon receipt and used to reconcile payment of the outstanding utility bill. The present invention further allows customers to pay for utility usage at any time during the month or prepay for utility usage in advance thereby securing consumption of a utility commodity at a predetermined rate. As such, the present invention allows a customer greater control and flexibility over payment options and provides payment to utility companies in an expedited and more efficient manner.

### BRIEF DESCRIPTION OF THE FIGURES

The features and advantages of the present invention reside in the details of construction and operation as more fully described and claimed below, with particular reference to the accompanying drawing figures, wherein like numerals refer to like parts throughout, and wherein:

FIG. 1 is a block diagram of an exemplary system for paying utility bills from a home utility meter terminal using an input device in accordance with one embodiment of the present invention;

FIG. 2 is a block diagram of an exemplary system for paying utility bills from a home utility meter terminal using a magnetic stripe card in accordance with one embodiment of the present invention;

FIG. 3 is block diagram of an exemplary system for wirelessly paying utility bills from a home utility meter terminal in accordance with one embodiment of the present invention;

FIG. 4 is a flow diagram showing an exemplary process of paying utility bills from a home utility meter terminal in accordance with one embodiment of the present invention; and

FIG. 5 is a flow diagram showing an exemplary process of pre-paying for utility usage from a home utility meter terminal in accordance with one embodiment of the present invention.

### DETAILED DESCRIPTION OF EXEMPLARY EMBODIMENTS

In general, in an exemplary embodiment of the present invention, a customer terminal 103 interfaces with a utility meter 102 to obtain utility usage information, then customer terminal 103 communicates with a utility provider server 122 via a communication network 120 to allow customers to pay for utility usage, such as gas, electricity, or water, from their own homes or businesses by providing payment information into an input device 116 associated with the utility meter.

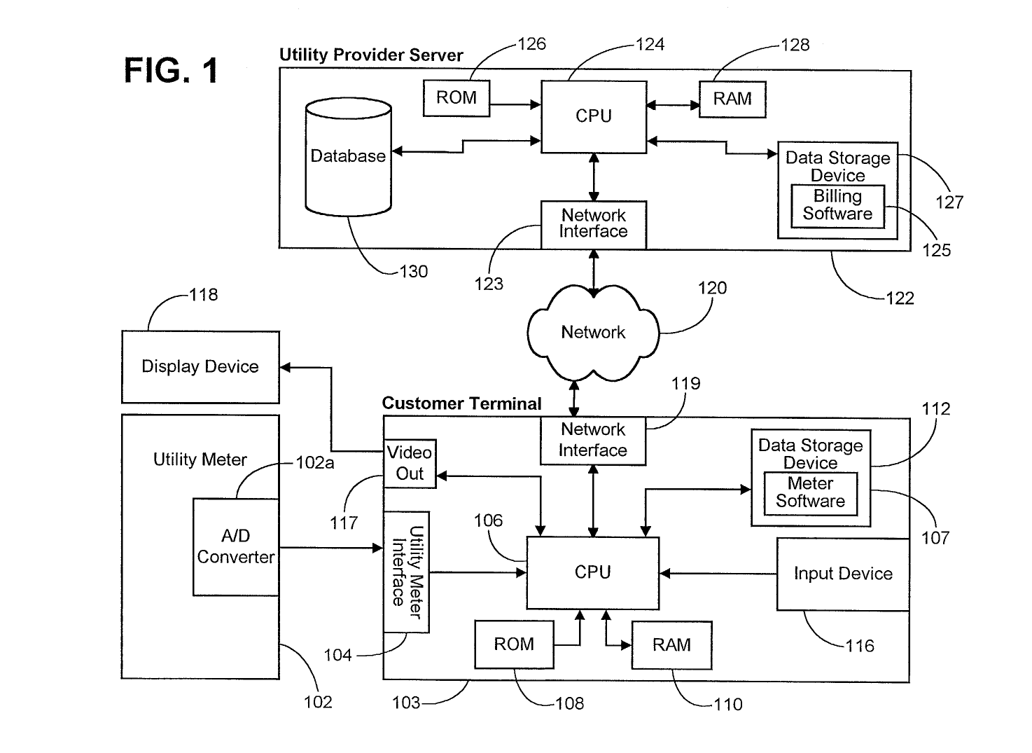

More particularly, utility meter 102 may be any hardware and/or software suitably configured to monitor and/or collect data regarding a customer's usage of any utility, goods and/or services, such as, for example, water, sewer, gas, electricity, cable television, and/or the like. In one embodiment, as provided in FIG. 1, utility meter 102 may include a water meter which is used to collect data regarding a customer's water usage. Many older models of utility meter 102 may use analog gauges to record usage data, wherein the usage data is then manually collected by the utility company on a periodic basis. As such, the present invention may include an analog to digital (A/D) converter 102a which is any hardware and/or software suitably configured to convert this analog data into digital data. Alternatively, meter 102 may obtain digital usage data which can be directly processed by customer terminal 103. The processing of data may occur in meter 102, in customer terminal 103 associated with the utility meter 102 or in any other device or system associated with the invention.

Customer terminal 103 may be any hardware and/or software suitably configured to interface with utility meter 102. Customer terminal 103 may also interface with input device 116, and/or utility provider server 122. In an exemplary embodiment, customer terminal 103 may also be any hardware and/or software suitably configured to collect utility usage data, customer transaction data, utility rate data, and/or the like, from utility meter 102, input device 116, and/or utility provider server 122. Additionally, customer terminal 103 may be configured to process and/or store utility usage data, customer transaction data, utility rate data, and the like. In an exemplary embodiment, customer terminal 103 interfaces with utility meter 102 via utility meter interface 104, and utility provider server 122 via network interface 119 and network 120.

Customer terminal 103 includes utility meter interface 104, wherein utility meter interface 104 includes any hardware and/or software that is suitably configured to interface with utility meter 102. In an exemplary embodiment, utility meter interface 104 is any hardware and/or software suitably configured to receive utility usage data from utility meter 102. Data may be transferred from utility meter 102 to utility meter interface 104 in any desired increment, including continuously, batch, daily, weekly, monthly, and/or at least twice daily for utilities billing at differential rates throughout the day, such as “time of use” billing arrangements and the like.

Processing unit 106 includes any hardware and/or software suitably configured to process data. In one embodiment, processing unit 106 may be any hardware and/or software configured to execute software associated with customer terminal 103. In another embodiment, processing unit may be suitably configured to execute utility meter software 107 stored on a data storage device 112 associated with customer terminal and interface with memory, such as RAM 108 and ROM 108.

Utility meter software 107 is any hardware and/or software suitably configured to perform any suitable operation in association with customer terminal 103. In one embodiment, utility meter software 107 is stored on a data storage device 112 associated with customer terminal 103. In another embodiment, utility meter software 107 is suitably configured to interface with utility input device 116, display device 118, utility meter 102, and/or utility provider server 122. In yet another embodiment, meter software 107 is configured to process usage data from utility meter 102, transmit usage data and/or billing information to display device 118, process account information from input device 116, and/or transmit payment information to utility provider server 122.

Data storage device 112 may be any hardware and/or software suitably configured for storing data. In one embodiment, data storage device 112 may contain utility meter software 107. Data storage devices, such as data storage device 112 (along with device 127 and database 130 in provider server 122), may be any hardware and/or software suitably configured to store digital data. Data storage devices in accordance with the present invention may be any type of database, such as relational, hierarchical, object-oriented, and/or the like. Common database products that may be used to implement data storage devices in accordance with the present invention may include DB2 by IBM (White Plains, N.Y.), any of the database products available from Oracle Corporation (Redwood Shores, Calif.), Microsoft Access by Microsoft Corporation (Redmond, Wash.), or any other similar database products that are now known or developed in the future. Further, data storage devices in accordance with the present invention may be organized in any suitable manner, including as data tables or lookup tables. Association of certain data may be accomplished through any data association technique now known or developed in the future. For example, the association may be accomplished either manually or automatically. Automatic association techniques may include, for example, a database search, a database merge, GREP, AGREP, SQL, and/or the like. The association step may be accomplished by a database merge function, for example, using a “key field” in customer terminal and utility provider server data tables. A “key field” partitions the database according to the high-level class of objects defined by the key field. For example, a certain class may be designated as a key field in both a first data table and a second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

An input device 116 suitably communicates with processing unit 106 and may include any device suitably configured to interact with the customer terminal 103. In an exemplary embodiment, the input device may include a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. In an exemplary embodiment, input device 116 includes any device capable of receiving payment, account number and/or account data including account information from a customer in a manner sufficient to pay for utility usage, such as a personal computer, bar code scanner, optical scanner, card reader and/or the like.

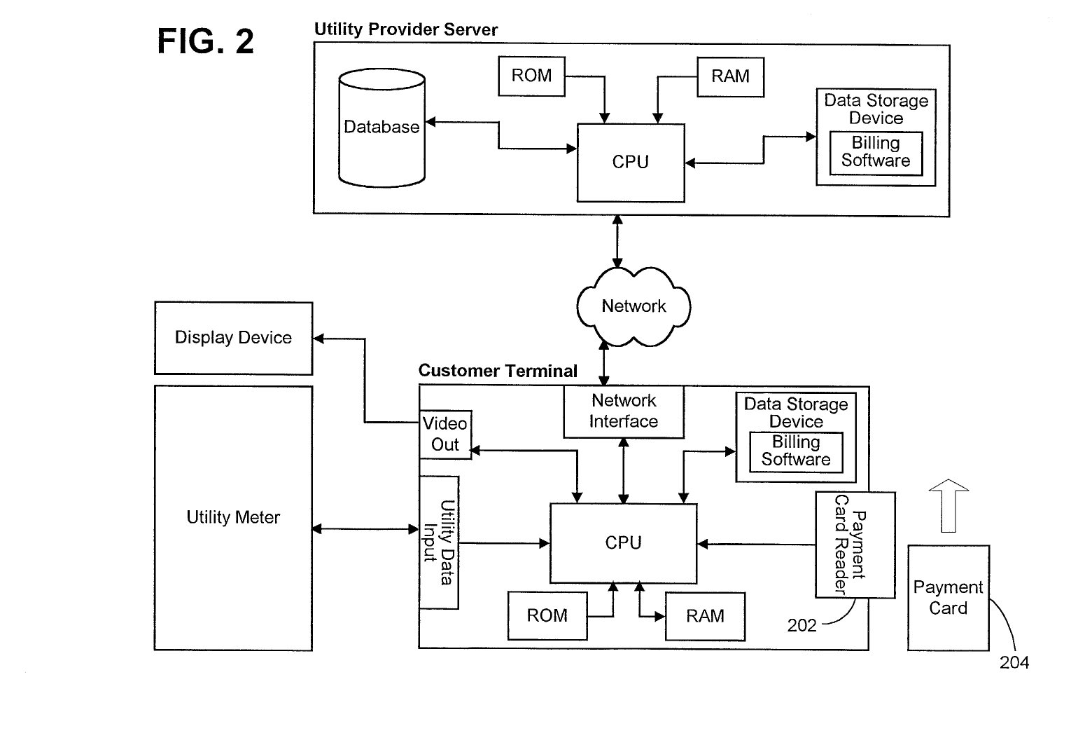

In one embodiment, as illustrated in FIG. 2, the input device 116 is configured as a magnetic card reader 202. In accordance with this embodiment, the magnetic card reader 202 is configured to read magnetically encoded digital data from a magnetic stripe on a payment card 204 where the payment card may include a debit card, a charge card, a credit card, and/or the like. Alternatively, input device 116 may be configured as a smart card reader or any other payment card reader capable of receiving account information. For more information related to an exemplary reader, see U.S. Pat. No. 5,905,908 owned by Datascape, Inc., which is hereby incorporated by reference.

An account number, as used herein, includes any device, code, or other identifier/indicia suitably configured to allow the consumer to interact or communicate with the utility provider server, such as, for example, authorization/access code, personal identification number (PIN), Internet code, other identification code, and/or the like which is optionally located on a charge card, credit card, debit card, prepaid card, telephone card, smart card, magnetic stripe card, bar code card, and/or the like. The account number may be distributed and stored in any form of plastic, electronic, magnetic, and/or optical device capable of transmitting or downloading data from itself to a second device, such as the input device associated with the customer terminal. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

A display device 118 also communicates with customer terminal 103. Display device 118 includes any hardware and/or software capable of displaying data to a customer, including a computer monitor, LCD, LED, and/or the like. In one embodiment, data is transmitted from customer terminal 103 to display device 118 via a video out interface 117. Video out interface 117 includes any hardware and/or software suitably configured to transmit data to a display device 118. Interactive data includes any data communicated to and from the customer by the customer terminal 103 and/or a utility provider server 122 including displaying usage data, rate data, customer billing data, account history information, prompting the customer to input payment information into the input device 116, as well as verifying completion of the payment transaction.

A network interface 119 in association with customer terminal 103 is provided, wherein the network interface includes any hardware and/or software that is suitably configured to interface with utility provider server 122 over a network. In an exemplary embodiment, network interface 119 is any hardware and/or software suitably configured to transmit and receive data from utility provider server 122. In a further embodiment, network interface 119 may be configured to receive data including customer account data, rate data, transmission verification data, encryption data, and the like. Additionally, network interface 119 may be suitably configured to transmit data including customer usage data, billing data, payment data, transmission verification data, encryption data, and the like. Data may be transferred to and from customer terminal 103 through network interface 119 in any desired increment, including continuously, batch, daily, weekly, and preferably monthly at the end of each billing cycle.

A utility provider server 122 may be any hardware and/or software suitably configured to interface with customer terminal 103, utility meter 102, and/or input device 116. In an exemplary embodiment, utility provider server 122 is any hardware and/or software suitably configured to collect utility usage data, customer transaction data, utility rate data, and the like, from utility meter 102, input device 116, and/or utility provider server 122. Additionally, customer terminal 103 may be configured to process and/or store utility usage data, customer transaction data, utility rate data, and the like.

Billing software 125 is any hardware and/or software configured to perform any suitable operation in association with utility provider server 122. In one embodiment, billing software 125 is stored on a data storage device 127 associated with utility provider server 122. In another embodiment, billing software 125 is suitably configured to interface with client terminal 103, display device 118, input device 116, and/or utility meter 102. In yet another embodiment, billing software 125 is configured to transmit rate data to customer terminal 103 and process billing and/or payment data received from customer terminal 103. Alternatively, billing software 125 may be configured to process usage data received from client terminal 103 to generate billing data, which is then retransmitted back to customer terminal 103.

A data storage device 127 associated with utility provider server 122 may be any hardware and/or software suitably configured for storing data. In one embodiment, data storage device 127 may contain billing software 125. A database 130 associated with utility provider server 122 may be any hardware and/or software suitably configured for storing data. In one embodiment, database 130 is configured for storing various information such as customer data, billing data, and rate data. Alternatively, database 130 may be stored on a separate computer or distributed across a plurality of computers electrically coupled to utility provider server 122 by a computer network. In yet another embodiment, database 130 may be distributed across a number of discrete databases maintained by different departments that comprise the utility provider.

A processing unit 124 interfaces with utility provider server 122 and includes any hardware and/or software suitably configured to process data. In one embodiment, processing unit 124 may be any hardware and/or software configured to execute software associated with utility provider server 122. In another embodiment, processing unit may be suitably configured to execute billing software 122 stored on a data storage device 127 and interface with various memory systems, such as ROM 126 and RAM 128.

A network interface 123 in association with utility provider server 122 is provided, wherein the network interface 123 includes any hardware and/or software that is suitably configured to interface with customer terminal 103 over a network. In one embodiment, network interface 123 is any hardware and/or software suitably configured to transmit and receive data from customer terminal 103. In another embodiment, network interface 123 may be configured to transmit data including customer account data, rate data, transmission verification data, encryption data, and the like. Additionally, network interface 123 may be configured to receive data including customer usage data, billing data, payment data, transmission verification data, encryption data, and the like. Data may be transferred to and from utility provider server 122 through network interface 213 in any desired increment, including continuously, batch, daily, weekly, and preferably monthly at the end of each billing cycle.

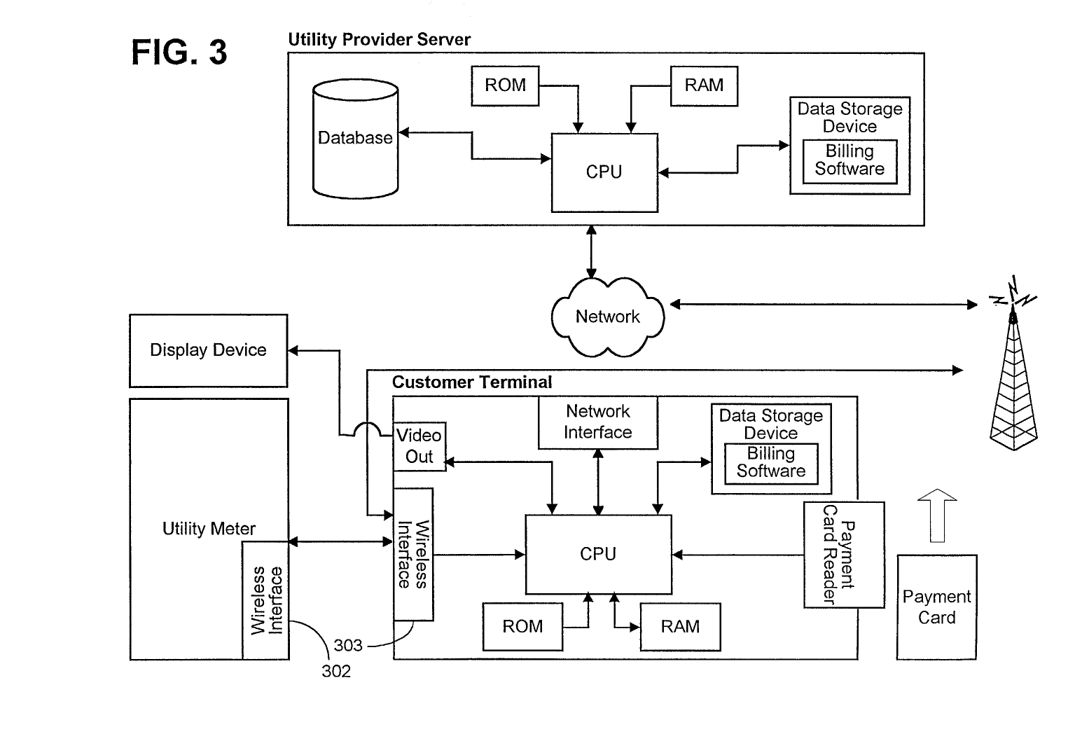

In an alternative embodiment, a wireless interface is provided. In one embodiment, a wireless interface capable of transmitting and/or receiving data is associated with the utility meter. Additionally, a wireless interface capable of transmitting and/or receiving data is also associated with the customer terminal. In another embodiment, as illustrated in FIG. 3, a wireless transceiver 302 is associated with the utility meter, and similarly, a wireless transceiver 303 is associated with the customer terminal. In accordance with the present invention, a suitable wireless interface includes an IrDA, radio frequency transceiver, cellular telephone, and/or the like. In accordance with a further aspect of this invention, usage data collected by the utility meter may be transmitted to the customer terminal by wireless interface 302 and received by wireless interface 303. Thereafter, the customer terminal may communicate with the utility provider server by way of tower 304, which connects to a wide area network such as the Internet. For example, the wireless transceiver 303 could transmit data over the cellular telephone network by communicating with the nearest cell tower, which in turn is connected to the Public Switched Telephone Network (PSTN) and the Internet. Alternatively, the transceiver could communicate with the utility server 122 by any other suitable transmission technology such as microwave or satellite transmission technology.

The customer terminal 103 and utility provider server 122 may be connected with each other via a data communication network 120. The network 120 may be a public network and assumed to be insecure and open to eavesdroppers. In the illustrated implementation, the network may be embodied as the Internet. In this context, the customer terminal and utility provider server may or may not be connected to the Internet at all times. For instance, the customer terminal may employ a modem to occasionally connect to the Internet, whereas the utility provider server might maintain a permanent connection to the Internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

It will be appreciated that many applications of the present invention could be formulated. One skilled in the art will appreciate that network 120 may include any system for exchanging data or transacting business, such as the Internet, an intranet, an extranet, WAN, LAN, satellite communications, and/or the like. It is noted that the network may be implemented as other types of networks, such as an interactive television (ITV) network. A variety of conventional communications media and protocols may be used. Such as, for example, a connection to an Internet Service Provider (ISP) over the local loop as is typically used in connection with standard modem communication, cable modem, Dish networks, ISDN, Digital Subscriber Line (DSL), or various wireless communication methods. Communications might also occur within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

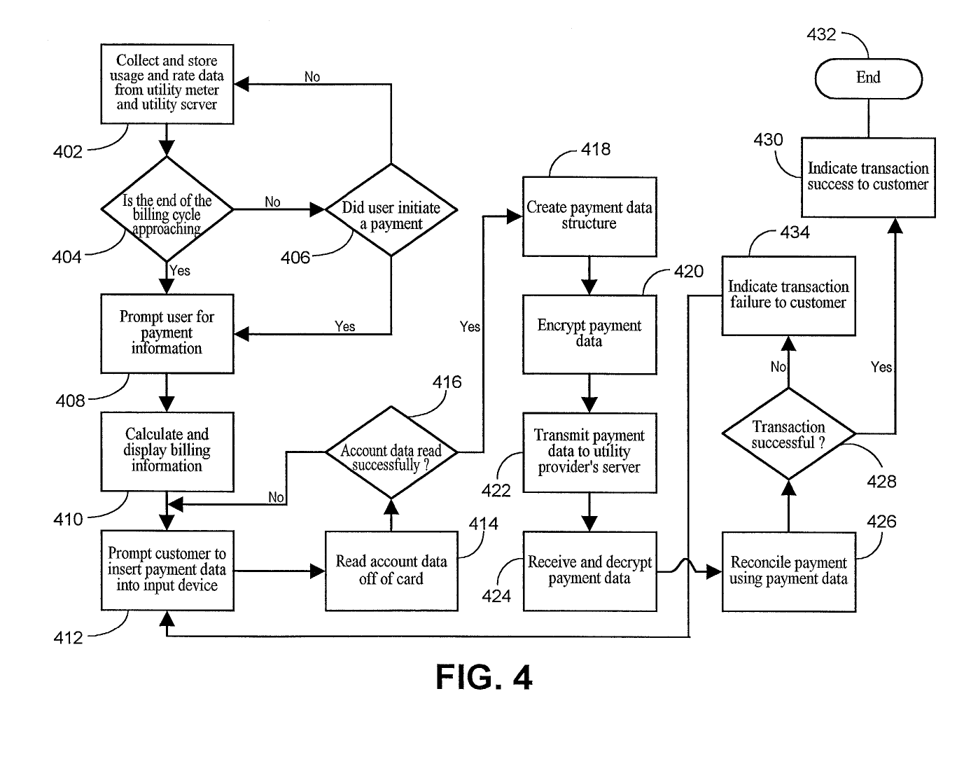

In accordance with a further aspect of the present invention, a method of paying utility bills with an input device associated with a utility meter is provided, as illustrated in FIG. 4. The functions and steps described below are not limited to being performed by or in the device discussed; rather, all or some of the functions may be performed in customer terminal 103, utility meter 102 or provider server 122. In an exemplary embodiment, the customer terminal 103 monitors and stores utility usage data received from utility meter 102 and rate data received from utility provider server 122 (step 402). At a predetermined date near the end of each billing cycle, the customer terminal 103 may prompt the customer to make a payment (step 404), such as, for example, by displaying an appropriate message in the display device 118 or activating a signal, such as a light on utility meter 102. Alternatively, the customer may initiate a payment by interacting with the customer terminal 103 independently (step 406). If neither condition is present, the customer terminal 103 will continue to collect and store usage data from the utility meter 102.

In one embodiment, when the end of the billing cycle is approaching or the customer indicates a desire to make a payment, the terminal 103 will prompt the customer for the financial instrument that will be used to make the payment (step 408), e.g., specific account number, debit card, credit card, smart card, and/or the like the customer will use for payment. The terminal may then calculate and display billing information based on usage data accumulated from the last payment date (step 410). Billing information may be calculated by using the customer's usage data and rate data downloaded from the utility meter 102 and/or utility provider server 122 as parameters to payment equations that are well known to those skilled in the art. Alternatively, the utility provider server 122 may calculate billing information based on usage data received from the customer terminal 103 and rate data stored on an associated data base 130. This billing information would then be transmitted to the customer terminal 103 and displayed to the customer on the display device 118 as described above.

Once the billing data has been calculated, the meter software 107 will prompt the customer to input payment data containing account information into the input device (step 412). In one embodiment, the meter software 107 may prompt the customer to insert a payment card into a payment card reader 202 as illustrated in FIG. 2. The payment card reader 202 may read the data off of card 204, as provided in step 414. The customer terminal 103 may then verify that the account data was read successfully (step 416). If the data was not read properly, the terminal 103 will return to step 412 and again prompt the customer to insert the payment card 204 into the payment card reader 202.

Once the account data is successfully read, it may be packaged into a payment data packet (step 418). The payment data packet includes all information necessary for the utility provider to reconcile the payment transaction. Exemplary data includes the customer account number, the amount of utility used, the total payment due, the total payment provided by the customer, customer identification data, and customer verification data. The data structure may then be encrypted before it is transmitted across the network (step 420). For example, the terminal can use a public key encryption system whereby the data is encrypted using the utility provider's public key, which can be decrypted only thorough the use of the utility's associated private key. Generating a unique public/private key pair for each of the utility's customers can further enhance system security. The encrypted data is sent over a communication network 120, such as the Internet, to the utility provider server 122 (step 422).

The payment data is received by the utility provider server 122 and may then be decrypted according to the particular encryption scheme employed by the system (step 424). The decrypted data may be used to reconcile the utility payment according to methods well known to those skilled in the art (step 426). If the transaction is successful (step 428), the server will send a confirmation message back to the customer terminal 103 (step 430) and the payment transaction is complete (step 432). The message may optionally include a reference number for the customer to refer to the transaction in the event of a dispute. If the transaction is unsuccessful (step 428), the server will transmit a message to the customer terminal that the transaction has failed (step 434) and the process will return to step 412 where the customer will once again be prompted to insert a payment 204 card into the payment card reader 202. All known settlement, dispute resolution, verifications, account changes, account inquiries and/or the like functions may be incorporated into the present invention. Moreover, other features such as creation of graphs related to utility, rate and payment data, notices of high usage, notices of lower rate times, distributing even payments throughout the year and/or the like may also be included in the invention.

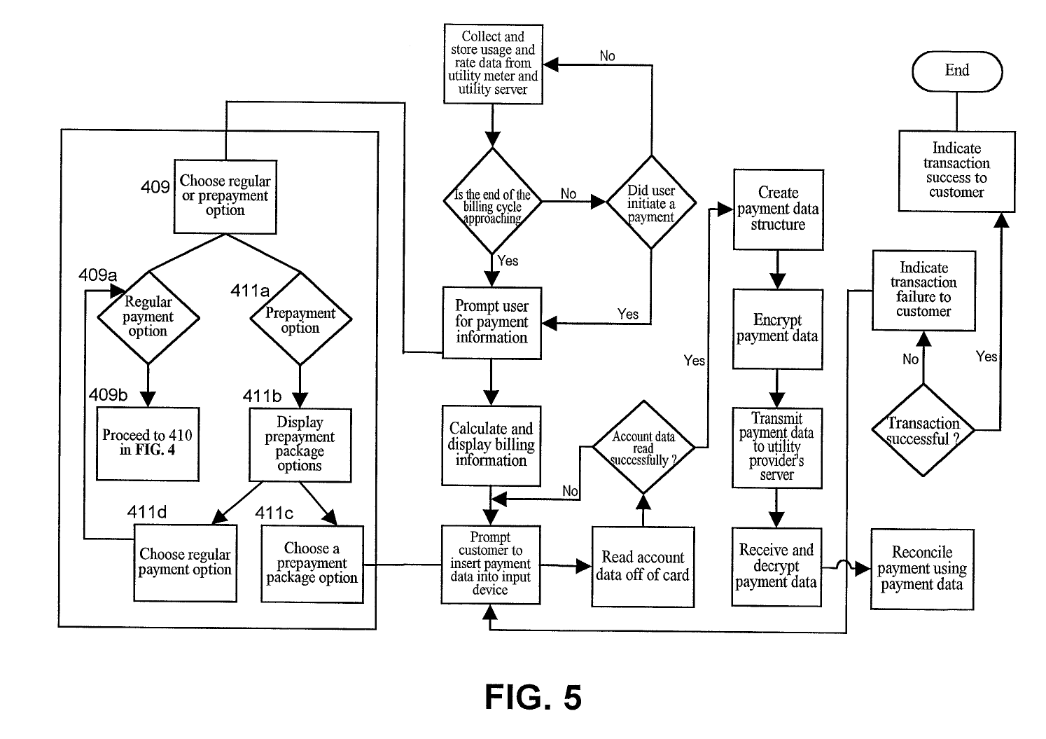

A method for pre-purchasing a specified amount of a utility at a fixed price using an input device associated with a utility meter in accordance with an additional embodiment of the invention is illustrated in FIG. 5. At the end of a billing cycle, or after the customer initiates a payment, the customer terminal 103 may prompt the customer to chose a regular payment option or a prepayment option (step 409). If the customer chooses a regular payment option (step 409a), the customer will be directed to make payment as outlined in step 410 and the steps following in FIG. 4 above (step 409b). If the customer selects the prepayment option (step 411a), the customer terminal 103 will display various prepayment package options received, for example, from the utility provider server 122 (step 411b). For example, a prepayment package may be provided at $0.13/kilowatt hour for 6000 total kilowatt hours along with another offering at $0.09/kilowatt hour for 12,000 total kilowatt hours. The customer will then select a package based on acceptable pricing and quantity offerings (step 411c). Alternatively, after reviewing the various pre-package offerings, the customer may opt out and instead proceed to the regular payment option (step 411d). If the customer selects a prepayment package, the customer will be directed to make payment for any outstanding balance as provided in step 410 in addition to the payment due for the selected prepaid package. Payment and processing then proceed according to step 412 and following as outlined in FIG. 4 above.

In another aspect of the present invention, utility payments may be made from a personal computer communicatively linked to, or in place of, the customer terminal 103. In one embodiment, utility usage and rate data is downloaded from the customer terminal 103 and displayed on a monitor associated with the personal computer. In one embodiment, customer account information may be entered into a keyboard associated with the personal computer. In another embodiment, account information may be entered through a payment card reader associated with the personal computer. Payment information may then be packaged into a payment data structure and transmitted to a utility provider server 122 through a communication network 120, such as the Internet, as provided above.

The above network embodiment of the present invention has been described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices, Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. For a basic introduction of encryption technology, or cryptography, please review a text written by Bruce Schneider which is entitled “Applied Cryptography: Protocols, Algorithms, And Source Code In C,” published by John Wiley & Sons (second edition, 1996), which is hereby incorporated by reference.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or the like.

Communication between the parties to the transaction and the system of the present invention is accomplished through any suitable communication means, such as, for example, a telephone network, Internet, intranet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as fireballs, access codes, encryption, de-encryption, compression, decompression, and/or the like.

While the invention has been described and illustrated in connection with preferred embodiments, many variations and modifications as will be evident to those skilled in the art may be made without departing from the spirit and scope of the invention, and the invention is thus not to be limited to the precise details of methodology or construction set forth above as such variations and modification are intended to be included within the scope of the invention.

I claim:

1. A system for remote payment of utility usage wherein said system comprises a customer terminal and a utility provider server, said system includes:
a customer terminal including a utility meter for collecting utility usage data wherein said utility meter is in communication with said customer terminal through a utility meter interface;
utility meter software configured to generate billing information comprising said usage data;
an input device associated with said customer terminal wherein said input device is configured to receive customer account information;
a network interface associated with said customer terminal wherein said network interface is configured to communicate with said utility provider server;
a utility provider server including a network interface associated with said utility provider server wherein said network interface is configured to communicate with said customer terminal; and
wherein said customer terminal generates a payment data packet comprising said billing information and said account information, said payment data packet is transmitted to said utility provider server.

2. The remote payment system of claim 1 wherein said utility meter further comprises an analog to digital converter configured to convert analog meter data from an analog meter into a digital data.

3. The remote payment system of claim 1 wherein said input device comprises a payment card reader, keyboard, mouse, kiosk, personal digital assistant, handheld computer, or cellular phone.

4. The payment card reader of claim 3 wherein said payment card reader is configured to read magnetic stripe cards, smart cards, or optical cards.

5. The remote payment system of claim 1 further comprising a display device associated with said customer terminal.

6. The remote payment system of claim 1 further comprising a wireless transceiver associated with said customer terminal.

7. The remote payment system of claim 1 further comprising a wireless transceiver associated with said utility provider server.

8. The remote payment system of claim 1 wherein said utility meter software is stored on a data storage device associated with said customer terminal.

9. The remote payment system of claim 1 wherein said utility server provider further comprises a database wherein said database comprises data including customer, rate, and billing information.

10. The remote payment system of claim 1 wherein said utility server further comprises billing software wherein said billing software reconciles said payment data packet received from said customer terminal.

11. A system for remote payment of utility usage wherein said system comprises a personal computer and a utility provider server, said system includes:
a personal computer associated with a utility meter for collecting utility usage data wherein said utility meter is in communication with said personal computer through a utility meter interface;
utility meter software configured to generate billing information comprising said usage data;
an input device associated with said personal computer wherein said input device is configured to receive customer account information;
a network interface associated with said personal computer wherein said network interface is configured to communicate with said utility provider server;
a utility provider server including a network interface associated with said utility provider server wherein said network interface is configured to communicate with said personal computer; and
wherein said personal computer generates a payment data packet comprising said billing information and said account information, and wherein said payment data packet is transmitted to said utility provider server.

12. The remote payment system of claim 11 wherein said utility meter further comprises an analog to digital converter configured to convert analog meter data from an analog meter into a digital data.

13. The remote payment system of claim 11 wherein said input device comprises a payment card reader, keyboard, mouse, kiosk, personal digital assistant, handheld computer, or cellular phone.

14. The payment card reader of claim 13 wherein said payment card reader is configured to read magnetic stripe cards, smart cards, or optical cards.

15. The remote payment system of claim 11 further comprising a wireless transceiver associated with said personal computer.

16. The remote payment system of claim 11 further comprising a wireless transceiver associated with said utility provider server.

17. The remote payment system of claim 11 wherein said utility meter software is stored on a database associated with said personal computer.

18. The remote payment system of claim 11 wherein said utility server provider further comprises a database wherein said database comprises data including customer, rate, and billing information.

19. The remote payment system of claim 11 wherein said utility server further comprises billing software wherein said billing software reconciles said payment data packet received from said personal computer.

20. A method of paying for utility usage using a utility meter in association with a customer terminal, said method includes:
monitoring and storing utility usage data from a utility meter;
obtaining rate data;
calculating billing information, wherein said billing information comprises said utility usage data and said rate data;
displaying said billing information on a display associated with said customer terminal;
receiving customer account information into an input device associated with said customer terminal;
preparing a payment data packet comprising customer account information and billing information; and
transmitting said payment data packet to a utility provider server.

21. The method according to claim 20 wherein said rate data is transmitted to said customer terminal from said utility server provider.

22. The method according to claim 20 wherein said rate data is manually entered into said customer terminal.

23. The method according to claim 20 wherein said payment data packet is encrypted prior to transmitting to said utility server provider.

24. The method according to claim 20 wherein said payment data packet is decrypted upon receipt by said utility server provider.

25. The method according to claim 20 wherein said utility provider server reconciles said payment data packet.

26. The method according to claim 20 wherein said utility provider server transmits a confirmation message back to said customer terminal upon verification of said payment data packet.

27. The method according to claim 20 wherein said utility provider server transmits an error message back to said customer terminal upon failure to verify said payment data packet.

28. A method of paying for utility usage using a utility meter in association with a customer terminal, said method includes:
monitoring and storing utility usage data from a utility meter;
transmitting said utility usage data to a utility provider server;
accessing rate data associated with said utility provider server;
calculating billing information comprising said utility usage data and rate data;
transmitting said billing information to said customer terminal;
displaying said billing information on a display associated with said customer terminal;
receiving customer account information into an input device associated with said customer terminal;
preparing a payment data packet comprising customer account information and billing information; and
transmitting said payment data packet to said utility provider server.

29. The method according to claim 28 wherein said payment data packet is encrypted prior to transmitting to said utility server provider.

30. The method according to claim 28 wherein said payment data packet is decrypted upon receipt by said utility server provider.

31. The method according to claim 28 wherein said utility provider server reconciles said payment data packet.

32. The method according to claim 28 wherein said utility provider server transmits a confirmation message back to said customer terminal upon verification of said payment data packet.

33. The method according to claim 28 wherein said utility provider server transmits an error message back to said customer terminal upon failure to verify said payment data packet.

34. A method of paying for utility usage using a utility meter in association with a customer terminal, said method includes:
transmitting a payment data packet from a customer terminal associated with a utility meter to a utility provider server wherein said payment data packet includes customer identification information, customer account information, and billing information; and
reconciling said payment data packet with data associated with said utility provider server.

35. The method of claim 34 wherein said utility provider server transmits a confirmation message back to said customer terminal upon verification of said payment data packet.

36. The method of claim 34 wherein said utility provider server transmits an error message back to said customer terminal upon failure to verify said payment data packet.

37. The method of claim 34 wherein said payment data packet includes customer identification information and customer information account information.

38. A method of payment for utility usage using a utility meter in association with a customer terminal, said method includes:
viewing utility usage and billing information on a display associated with a customer terminal;
entering customer account information into an input device associated with said customer terminal; and
authorizing an expenditure of a specified amount to said customer account.

39. The method of claim 38 wherein said customer terminal prompts the customer to make payment.

40. The method of claim 38 wherein said customer initiates payment.

41. The method of claim 38 wherein said input device comprises a payment card reader, keyboard, mouse, kiosk, personal digital assistant, handheld computer, or cellular phone.

42. The method of claim 38 wherein said payment card reader is configured to read magnetic stripe cards, smart cards, or optical cards.

43. A method of paying for utility usage through a utility meter in association with a customer terminal wherein said method comprises pre-purchasing said utility prior to usage, said method includes:
displaying at least one prepayment package in a display associated with said customer terminal wherein said prepayment package includes at least one prepayment option for prepayment of a specified quantity of a utility at a fixed rate;
receiving selection of at least one prepayment option and receiving customer account information into an input device associated with said customer terminal;
preparing a payment data packet comprising the prepayment option selected, and customer account information; and
transmitting said payment data packet to said utility provider server.

44. The method according to claim 43 wherein said payment data packet is encrypted prior to transmitting to said utility server provider.

45. The method according to claim 43 wherein said payment data packet is decrypted upon receipt by said utility server provider.

46. The method according to claim 43 wherein said utility provider server reconciles said payment data packet.

47. The method according to claim 43 wherein said utility provider server transmits a confirmation message back to said customer terminal upon verification of said payment data packet.

48. The method according to claim 43 wherein said utility provider server transmits an error message back to said customer terminal upon failure to verify said payment data packet.
